(19) United States
(12) Patent Application Publication
(10) Pub. No.: US 2010/0045610 A1
(43) Pub. Date: Feb. 25, 2010

(54) TRANSPARENT CONDUCTIVE FILMS

(75) Inventors: Seunghun Hong, Seoul (KR); Moon Gyu Sung, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SNU R&DB FOUNDATION, Gwanak-gu (KR)

(21) Appl. No.: 12/195,356

(22) Filed: Aug. 20, 2008

(51) Int. Cl. G06F 3/041; B32B 9/00; B05D 5/00

(52) U.S. Cl. 345/173; 428/697; 427/108; 427/109; 427/110; 977/742; 977/750; 977/752

(57) ABSTRACT

A transparent conductive film comprised of a carbon nanotube network and indium tin oxide composite and a method for manufacturing the transparent conductive film are provided.

### TECHNICAL FIELD

The present disclosure relates generally to transparent conductive films.

### BACKGROUND

Optically transparent and electrically conductive films may be useful in some application fields including, but not limited to, touch screens, flat panel displays such as LCD, PDP, OLED and FED, transparent EMI shielding films, transparent heating films, gas sensors, solar cells and planar antennas for fiber-optic communications. As used herein, if a layer of material or a sequence of several layers of different materials permit at least 50% of ambient light within a visible wavelength region (i.e., the region of 400-800 nm) to be transmitted through the layer or layers, the layer or layers may be said to be optically “transparent” or to have “transparency.”

The conventional transparent conductive films are comprised of metal oxides, such as but not limited to, indium tin oxide (ITO), which provides optical transparency as well as relatively good electrical conductivity. However, compared to metals such as Ag and Cu, the ITO based films have relatively low electrical conductivity and so inevitably, they offer restricted electrical performance in some of the above application fields. In addition, the ITO based films have relatively brittle nature and accordingly inferior abrasion resistance. Further, with the recent rapid growth and expansion of the display industry, the price of indium, one of the main components of ITO, has rapidly increased and thus the supply of indium has been limited. Therefore, the transparent conductive films comprised of only ITO may cause physical and economical restrictions in some of the above application fields.

In this respect, carbon nanotubes (CNTs) have recently been given significant attention as new materials for transparent conductive films due to their properties such as optical transparency and electrical conductivity. When the CNTs are deposited on a transparent substrate, the cylindrical CNTs form CNT networks on the substrate that allow the substrate to have good electrical conductivity. Further, the CNT deposited substrate can still maintain high transparency due to their length-to-diameter ratio property.

However, although individual CNTs have preeminent conductivity to be competitive with metal, the CNT networks usually have relatively low conductivity due to the empty space between individual CNTs in the network. Therefore, the transparent conductive films including the CNT networks have not been able to achieve sufficient sheet conductance equivalent to the high conductance of the individual CNTs.

### SUMMARY

A transparent conductive film, methods for manufacturing the transparent conductive film, and various applications of the transparent conductive film are provided. In one embodiment, a transparent conductive film comprises a carbon nanotube network and an indium tin oxide composite.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram of an illustrative embodiment of a transparent conductive film.

FIG. 2 is a flow chart of an illustrative embodiment of a method for manufacturing a transparent conductive film.

FIG. 3 is a schematic diagram of an illustrative embodiment of a touch screen using a transparent conductive film.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

The present disclosure provides a transparent conductive film which may comprise a carbon nanotube network and an indium tin oxide composite.

In one embodiment, the carbon nanotube network and indium tin oxide composite may comprise a carbon nanotube network layer and an indium tin oxide layer disposed on the carbon nanotube network.

In another embodiment, the carbon nanotube network layer may comprise a metallic single walled carbon nanotube network layer.

In yet another embodiment, the carbon nanotube network layer may comprise a metallic multi walled carbon nanotube network layer.

The present disclosure also provides a method for manufacturing a transparent conductive film comprised of a carbon nanotube network and indium tin oxide composite. The method may comprise providing a transparent substrate, disposing a metallic type carbon nanotube solution onto the transparent substrate, forming a metallic carbon nanotube network layer from the metallic carbon nanotube solution, and disposing an indium tin oxide layer over the metallic carbon nanotube network layer.

In one embodiment, the action of forming the metallic carbon nanotube network layer may comprise utilizing at least one of laser ablation, carbon arc or chemical vapor deposition (CVD).

In another embodiment the action of disposing the metallic carbon nanotube solution may comprise dispersing the carbon nanotube powder in a solvent to make a carbon nanotube solution and isolating the metallic carbon nanotube solution from the carbon nanotube solution.

In yet another embodiment, the action of disposing the metallic carbon nanotube solution may comprise disposing a metallic single walled carbon nanotube solution.

In yet another embodiment, the action of disposing the metallic carbon nanotube solution may comprise disposing a metallic multi walled carbon nanotube solution.

In yet another embodiment, the action of isolating the carbon nanotube solution may comprise utilizing a density-gradient ultracentrifugation technique using a structure discriminating surfactant.

In yet another embodiment, the action of disposing of the metallic carbon nanotube solution onto the transparent substrate may comprise disposing at least one of spray coating or dip coating techniques.

In yet another embodiment, the action of disposing of the indium tin oxide layer may comprise utilizing at least one of via sputtering or chemical vapor deposition techniques.

In yet another embodiment the method may further comprise repeating the disposing of the metallic carbon nanotube solution, and the disposing of the indium tin oxide layer on top of the metallic carbon nanotube layer alternately one or more times.

In yet another embodiment, the method may further comprise annealing the transparent conductive film.

The present disclosure also provides a touch screen which may comprise a transparent substrate, a first transparent conductive film disposed on the transparent substrate, a second transparent conductive film disposed opposite to the first transparent conductive film, and an air gap layer disposed between the first and the second transparent conductive films. The first and the second transparent conductive films are composite films including a carbon nanotube network and indium tin oxide composite.

In one embodiment, a plurality of dot spacers may be placed in the air gap layer to maintain the space between the first and the second transparent conductive films.

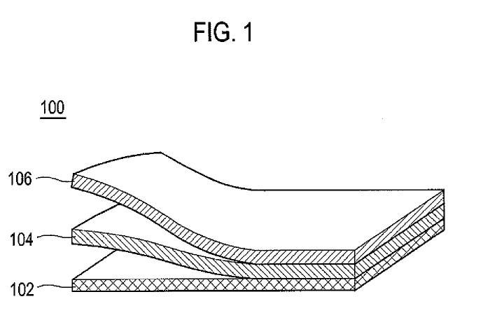

FIG. 1 is a schematic diagram of an illustrative embodiment of a transparent conductive film 100. As depicted, the transparent conductive film 100 is configured to include a carbon nanotube network layer 104 on a substrate 102 and an indium tin oxide (ITO) layer 106 deposited on the carbon nanotube layer.

The substrate 102 may be an optically clear substrate such as, but not limited to, PET, glass, plastic, ceramic, etc. In particular, if a flexible substrate such as a plastic film is used, the resulting conductive film can also have good flexibility.

The CNT network layer 104 is disposed on the substrate 102. In one embodiment, the CNT network layer 104 may be formed by applying a CNT solution onto the substrate 102. For example, the CNT network layer 104 may be formed through various methods, including, but not limited to, spraying and dip coating methods.

The CNTs may be categorized as single-walled carbon nanotubes, double-walled carbon nanotubes, and multi-walled carbon nanotubes, and accordingly not to be limited in these respects. These forms of the CNTs may be synthesized by several methods such as laser ablation, carbon arc and chemical vapor deposition (CVD). Among them, single-walled carbon nanotubes have especially high electrical conductivity in addition to good mechanical properties. In one embodiment, the CNT network layer 104 may be comprised of single-walled carbon nanotubes having relatively excellent conductivity. Alternatively, in another embodiment, the CNT network layer 104 may be comprised of multi walled carbon nanotubes having metallic type properties.

The ITO layer 106 is disposed on the CNT network layer 104. In one embodiment, the ITO layer 106 may be deposited on the top of the surface of the CNT network layer 104 via various methods, including, but not limited to, sputtering, chemical vapor deposition, and spray pyrolysis methods, and accordingly not to be limited in these respects.

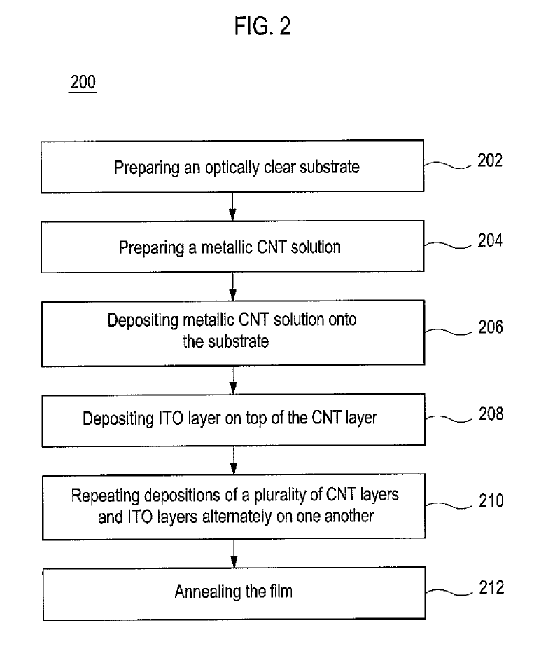

FIG. 2 is a flow chart of an illustrative embodiment of a method for manufacturing a transparent conductive film. In block 202, an optically clear substrate is prepared. As discussed above in connection with FIG. 1, the substrate may be, for example, comprised of PET, glass, plastic, ceramic, etc. For a flexible display panel, it may be desirable to use a flexible substrate such as flexible plastic rather than conventional glass.

In block 204, a metallic CNT solution is prepared to be deposited onto the substrate. In one embodiment, a carbon nanotube solution may be prepared by first dispersing carbon nanotube powder in an adequate solvent. The solvent may be selected among several varieties known in the art. In one embodiment, the carbon nanotube may be single walled CNTs. Alternatively, in another embodiment, multi walled CNTs which already have metallic type properties may also be used.

As-synthesized single walled CNTs may vary in their diameter and chiral angle. Thus, these physical variations may affect their electronic and optical behaviors. Some single walled CNTs may exhibit metallic properties while some may inhibit semiconductor type properties. Therefore, an isolating process for the carbon nanotube solution may be utilized in order to obtain the desired metallic single walled CNTs.

In one embodiment, the isolating process may be performed through a technique of density-gradient ultracentrifugation using one or more structure discriminating surfactants. This approach may utilize differences in the buoyant densities among single walled CNTs of different structures. In this technique, purification may be induced by ultracentrifugation in a density gradient. In response to the resulting centripetal force, particle sediment toward respective buoyant densities may be spatially separated in the gradient.

In block 206, the prepared metallic CNT solution is deposited onto the substrate to form a CNT network layer. In one embodiment, the metallic CNT solution may be absorbed onto the substrate via spray coating or dip coating techniques so as to form the CNT network layer.

Then, in block 208, the ITO layer may be deposited on the top of the CNT layer. In one embodiment the ITO layer may be deposited via a sputtering technique. In such case, a mixture powder including proper portions of indium and tin respectively may be formed and sintered to make an ITO deposition source target. Then, using the ITO source target, sputtering may be performed in a chamber so that the ITO layer is deposited on the CNT layer. Alternatively, chemical vapor deposition (CVD) may be adapted to deposit the ITO layer on the CNT layer. In this case, the resulting thickness of the ITO layer may be relatively controllable and uniform.

In one embodiment, a plurality of CNT layers and ITO layers may be deposited alternately on one another to make a multiple-layered thick film in block 210. Further, in one embodiment, after deposition of the CNT and ITO layers, the film may be annealed to improve contact resistance in block 212.

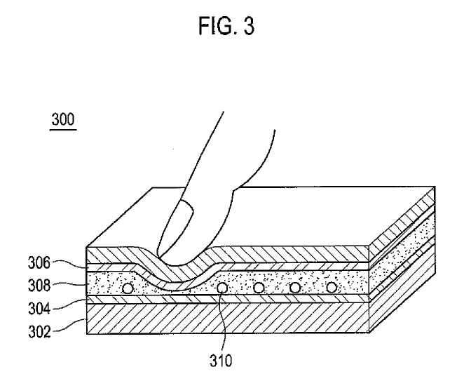

FIG. 3 is a schematic of an illustrative embodiment of a touch screen 300 using a transparent conductive film. As depicted, the touch screen 300 includes a substrate 302 and a first transparent conductive film 304 formed on the substrate 302. The touch screen 300 also includes a second transparent conductive film 306. The first and the second transparent conductive films 304, 306 may be composite films including the CNT network layer and the ITO layer as illustrated in FIG. 1. The first and the second transparent conductive films 304, 306 may be disposed to be opposite to each other with an air gap layer 308 between them. In the air gap layer 308, a plurality of dot spacers 310 may be placed to maintain the space between the first and the second transparent conductive films 304, 306. Compared to a conventional touch screen having transparent conductive films only comprised of ITO materials, the touch screen 300 may have improved electric conductivity as well as improved mechanical stability.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A transparent conductive film, comprising a carbon nanotube network and an indium tin oxide composite.

2. The transparent conductive film of claim 1, wherein the carbon nanotube network and indium tin oxide composite comprise a carbon nanotube network layer and an indium tin oxide layer disposed on the carbon nanotube network.

3. The transparent conductive film of claim 2, wherein the carbon nanotube network layer comprises a metallic single walled carbon nanotube network layer.

4. The transparent conductive film of claim 2, wherein the carbon nanotube network layer comprises a metallic multi walled carbon nanotube network layer.

5. A method for manufacturing a transparent conductive film comprised of a carbon nanotube network and indium tin oxide composite, wherein the method comprises:
providing a transparent substrate;
disposing a metallic type carbon nanotube solution onto the transparent substrate;
forming a metallic carbon nanotube network layer from the metallic carbon nanotube solution; and
disposing an indium tin oxide layer over the metallic carbon nanotube network layer.

6. The method for manufacturing the transparent conductive film of claim 5, wherein the forming the metallic carbon nanotube network layer comprises utilizing at least one of laser ablation, carbon arc or chemical vapor deposition (CVD).

7. The method for manufacturing the transparent conductive film of claim 5, wherein the disposing the metallic carbon nanotube solution comprises dispersing carbon nanotube powder in a solvent to make a carbon nanotube solution and isolating the metallic carbon nanotube solution from the carbon nanotube solution.

8. The method for manufacturing the transparent conductive film of claim 5, wherein the disposing metallic carbon nanotube solution comprises disposing a metallic single walled carbon nanotube solution.

9. The method for manufacturing the transparent conductive film of claim 5, wherein the disposing the metallic carbon nanotube solution comprises disposing a metallic multi walled carbon nanotube solution.

10. The method for manufacturing the transparent conductive film of claim 7, wherein the isolating the carbon nanotube solution comprises utilizing a density-gradient ultracentrifugation technique using a structure discriminating surfactant.

11. The method for manufacturing the transparent conductive film of claim 5, wherein the disposing of the metallic carbon nanotube solution onto the transparent substrate comprises disposing at least one of spray coating or dip coating techniques.

12. The method for manufacturing the transparent conductive film of claim 5, wherein the disposing of the indium tin oxide layer comprises utilizing at least one of via sputtering or chemical vapor deposition techniques.

13. The method for manufacturing the transparent conductive film of claim 5, further comprising:
repeating the disposing of the metallic carbon nanotube solution and the disposing of the indium tin oxide layer on top of the metallic carbon nanotube layer, alternately, one or more times.

14. The method for manufacturing the transparent conductive film of claim 5, further comprising annealing the transparent conductive film.

15. A touch screen, comprising:
a transparent substrate;
a first transparent conductive film disposed on the transparent substrate;
a second transparent conductive film disposed opposite to the first transparent conductive film; and
an air gap layer disposed between the first and the second transparent conductive films,
wherein the first and the second transparent conductive films are composite films including a carbon nanotube network and indium tin oxide composite.

16. The touch screen of claim 15, wherein a plurality of dot spacers is placed in the air gap layer to maintain the space between the first and the second transparent conductive films.
